(19) United States
(12) Patent Application Publication
(10) Pub. No.: US 2007/0284447 A1
(43) Pub. Date: Dec. 13, 2007

(54) VARIABLE ILLUMINATION SCANNING

(75) Inventor: Alexander M. McQueen, Eugene, OR (US)

Correspondence Address: DATALOGIC - STOEL RIVES LLP;C/O STOEL RIVES LLP, 900 SW 5TH AVENUE, SUITE 2600, PORTLAND, OR, 97204, US

(73) Assignee: DATALOGIC SCANNING, INC., Portland, OR (US)

(21) Appl. No.: 11/753,452

(22) Filed: May 24, 2007

Related U.S. Application Data
(60) Provisional application No. 60/808,413, filed on May 25, 2006.

(51) Int. Cl. G06K 7/10

(52) U.S. Cl. 235/454; 235/462.42

(57) ABSTRACT

Disclosed are embodiments of methods, systems, and apparatus for varying the illumination in a data reader or data reading system. In one embodiment, an illumination source for illuminating an optical code on an item is provided. A control may also be provided for activating the illumination source. The illumination source may be configured to undergo an illumination sequence in response to an activation of the control. The illumination sequence gradually increases the intensity of the illumination source perceptible to a user over time so as to reduce the user's fatigue and/or irritation associated with the illumination source.

### RELATED APPLICATION DATA

This application claims the benefit under 35 U.S.C. § 119(e) of U.S. Provisional Patent Application No. 60/808,413, filed May 25, 2006, and titled “Variable Illumination Scanning,” hereby incorporated by reference.

### BACKGROUND

The field of the present invention relates generally to systems and methods for data reading. More particularly, it relates to systems, methods, and apparatus for varying the illumination in a data reader or data reading system.

Image capture and other data reading devices are used to read optical codes, acquire data, and capture a variety of images. One common data acquisition device is an optical code reader. Optical codes typically comprise a pattern of dark elements and light spaces. There are various types of optical codes, including 1-D codes (such as UPC and EAN/JAN barcodes) and 2-D codes (such as PDF-417 and Maxicode). It should be understood, however, that the embodiments described herein may be useful for readers used in connection with any type of code or symbol, including fingerprint capture, and nothing herein should be construed as limiting this disclosure to optical codes or any other particular type of code.

One type of data reader is an imaging reader that employs an imaging device or sensor array, such as a CCD (charge coupled device) or CMOS device. Imaging readers can be configured to read both 1-D and 2-D optical codes, as well as other types of optical codes, symbols, and images of other items. When an imaging reader is used to read an optical code, an image of the optical code or portion thereof is focused onto a detector array. Though some imaging readers are capable of using ambient light illumination, many imaging readers utilize an illumination source to illuminate the item being read and thereby provide the required signal response in the imaging device. For example, optical code readers using image sensor technology are often provided with supplemental illumination. Such extra illumination may be provided for the purpose of delineating the reader field of view to allow the user to aim the device. Supplemental reader illumination may also facilitate low-noise image capture.

In some situations, the amount of supplemental illumination required for effectiveness may be substantial, and the present inventor has recognized that the cycling of this illumination on and off may be irritating to the operator and may also result in fatigue. The present inventor has therefore determined that it would be desirable to provide a data reader that improves on these or other such limitations.

### BRIEF DESCRIPTION OF THE DRAWINGS

Understanding that drawings depict only certain preferred embodiments and are not therefore to be considered to be limiting in nature, the preferred embodiments will be described and explained with additional specificity and detail through the use of the accompanying drawings in which:

FIG. 1 is a schematic view of an embodiment of a data reader.

FIG. 2 is an example of an illumination-driving waveform to gradually increase the intensity of the illumination perceived by a user.

FIG. 3 is an example of a function for linearly increasing the perceived intensity of an illumination source by continuously increasing the actual intensity of the illumination source.

FIG. 4 is a flowchart illustrating one embodiment of a method for using a data reader having a digital illumination source.

FIG. 5 is a flowchart illustrating one embodiment of a method for using a data reader having an analog illumination source.

### DETAILED DESCRIPTION OF PREFERRED EMBODIMENTS

In the following description, numerous specific details are provided for a thorough understanding of specific preferred embodiments. However, those skilled in the art will recognize that embodiments can be practiced without one or more of the specific details, or with other methods, components, materials, etc.

In some cases, well-known structures, materials, or operations are not shown or described in detail in order to avoid obscuring aspects of the preferred embodiments. Furthermore, the described features, structures, or characteristics may be combined in any suitable manner in one or more embodiments.

Disclosed herein are embodiments of methods, systems, and apparatus for varying the illumination in a data reader or data reading system. In one embodiment, a data reading system may have a plurality of configurable illumination modes available that the user may select among. In one of the available modes, the intensity of the illumination source perceived by the user may be gradually increased. Various methods may be used to gradually increase the intensity of the illumination source perceived by the user, such as, for example: (1) increasing the actual intensity of the illumination source; or (2) gradually increasing the duty cycle of the illumination-driving waveform, which may be particularly useful with digital illumination sources.

In some embodiments, the rate at which the perceived intensity increases may be adjusted by the user. The rate at which the perceived intensity is increased may vary considerably as desired. In some embodiments, the range for the rate of increase between actuating a ramping control and reaching a perceived maximum intensity may be between about 0.1 seconds and about 1.5 seconds). In other embodiments, the range for the rate of increase may be between about 0.5 seconds and about 1 second.

Likewise, the profile of the increase as a function of time may also be configurable by the user in some embodiments. For example, the profile may be selected as linear, exponential, sinusoidal, etc. Any of the foregoing profiles may be used permanently in a given embodiment, or may be selected as desired by a user in other embodiments. For example, the data reader may be configured to initiate the perceived illumination intensity increase with a control, such as a trigger control.

Some embodiments may also, or alternatively, allow for a gradual decrease in the intensity of the illumination perceived by the user. In embodiments providing for both a gradual increase and decrease in perceived illumination intensity, the same control may be used to initiate the increase and the decrease or, alternatively, a separate control from the control used to initiate the increase may be used to initiate the decrease sequence. In embodiments utilizing the same control for both functions, the control may be “single-clicked” to initiate an increase sequence and “double-clicked” to initiate a decrease sequence, for example. Alternatively, the device may be configured to automatically initiate a decrease sequence whenever the control is activated during an increase sequence, or while the illumination source is on, for example.

By making the transitions during which the illumination source is turned on and/or turned off gradual, user fatigue and irritation may be reduced. As mentioned above, the rate of the increases/decreases may be configurable in some embodiments, such that the user may select a reasonable tradeoff between the amount of fatigue reduction and the effect of the selected transition rate on other characteristics of the device, such as reading performance and power consumption.

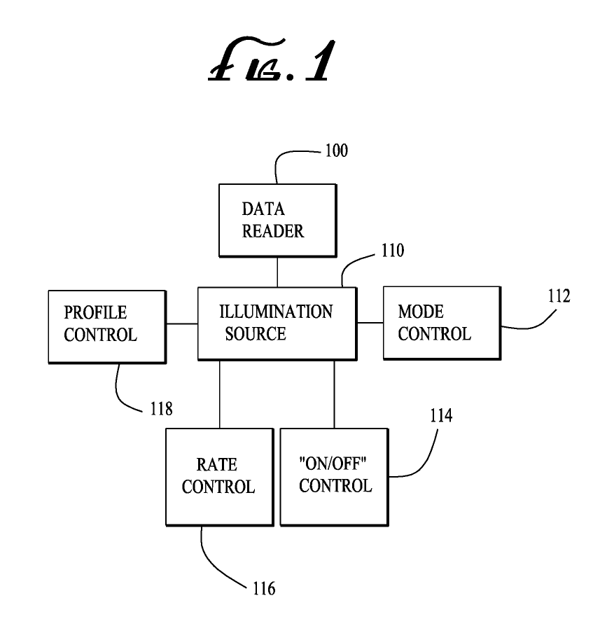

FIG. 1 is a schematic view of one embodiment of a data reader 100. Data reader 100 includes an illumination source 110. The illumination source 110 may be a digital or analog source, as will be described in greater detail below. The illumination source 110 is operatively connected with a series of controls. Mode control 112 may be used to switch between various illumination modes. For example, mode control 112 may allow for switching between a “standard” illumination mode, in which the intensity of the illumination source 110 does not increase gradually, and a “ramping” mode, in which the perceived intensity of the illumination source 110 increases gradually.

“On/off” control 114 may be used to turn the illumination source 110 on or off. In “standard” mode, activation of control 114 may be used to immediately turn illumination source 110 on at its highest intensity. In “ramping” mode, activation of control 114 may instead cause illumination source 110 to gradually increase in intensity (or at least in intensity perceived by the user) in accordance with a desired profile and/or rate. Rate control 116 allows the user to vary the rate with which the intensity (or perceived intensity) of illumination source 110 increases (or decreases). Profile control 118 likewise allows the user to adjust the profile of the increase with respect to time. For example, profile control 118 may allow a user to select between linear, exponential, and sinusoidal intensity profiles.

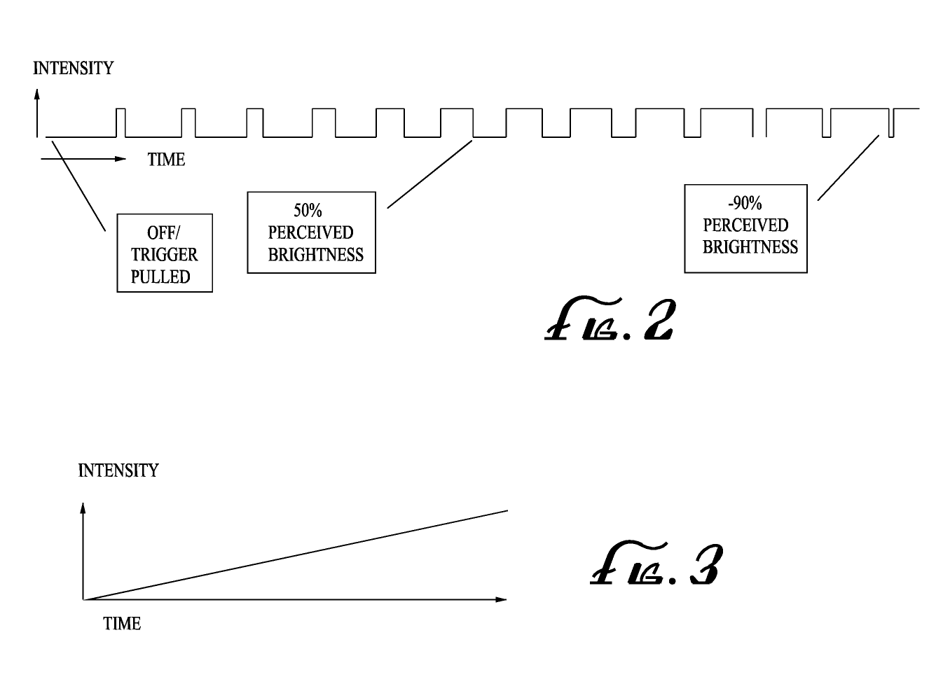

FIG. 2 illustrates an example of a digital illumination-driving waveform that gradually increases the perceived intensity of illumination by gradually increasing the percentage of time during which the illumination source is on. In other words, the duty cycle of the illumination waveform is gradually increased. As illustrated in the figure, once the illumination source is activated, by activating a trigger control, for example, the digital illumination source is intermittently turned on and off. The percentage of time during which the illumination source is on (the duty cycle) is gradually increased. At approximately the mid-point of the timeline of the graph, the perceived brightness of the digital illumination source is approximately fifty percent. Near the end of the graph's timeline, at which point the gaps between the “on” state are becoming relatively small, the perceived brightness is approximately ninety percent.

In some embodiments, the imaging sensor of the reader may be synchronized with the illumination source, such that the integration of the image on the sensor corresponds to a specific, desired portion of the illumination sequence. For sensors that expose all pixels of an image simultaneously, the integration of the image on the sensor may start at or near the beginning of the illumination sequence.

FIG. 3 presents a graph showing a linear adjustment of the intensity of an illumination source. The illumination source corresponding to the graph of FIG. 3 is continuously adjustable or analog, in contrast to the digital illumination source used to generate the waveform in FIG. 2. In one embodiment of a device having an illumination source that can generate a continuously increasing and/or decreasing intensity function, such as that shown in FIG. 3, a rolling shutter may be provided. As those having ordinary skill in the art will appreciate, a “rolling shutter” is a specific methodology for operating an image sensor. According to this methodology, each row of pixels may be exposed in turn, rather than exposing all rows simultaneously. The relative timing of the shutter exposure and the illumination sequence may be used to determine the amount of energy integrated by the pixels of the sensor. Like other embodiments described above, the rate and profile of the continuous increase and/or decrease may be adjustable by the user in certain embodiments.

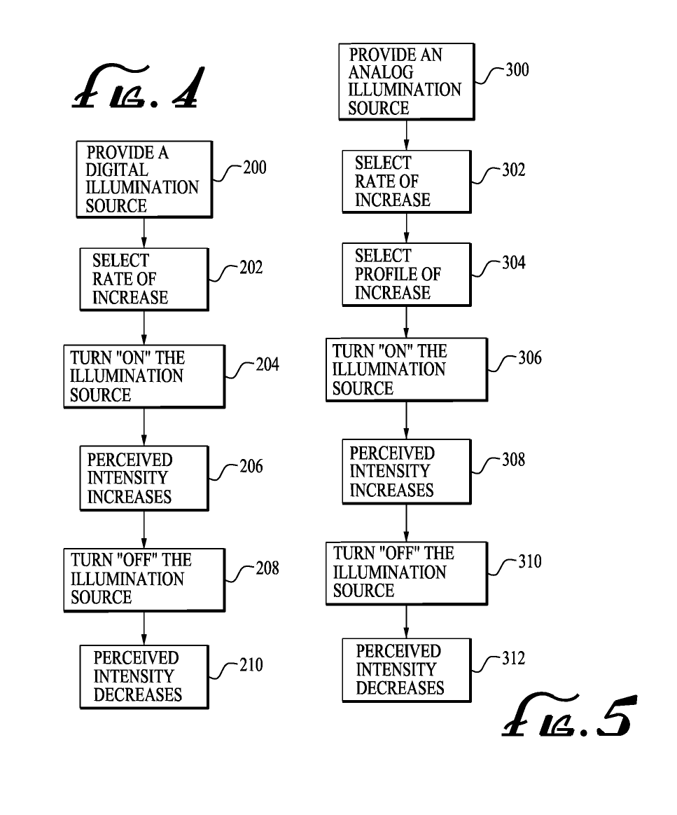

FIGS. 4 and 5 are flow-charts showing some illustrative methods according to particular embodiments described herein. In the method of FIG. 4, a digital illumination source is provided at 200. The desired rate of increase of the digital illumination source is then selected at 202. The illumination source is then turned “on” at step 204 via a control, such as control 114 shown in FIG. 1. After turning on the illumination source, the perceived intensity of the illumination source gradually increases in step 206. In some embodiments, the perceived illumination intensity may be increased based upon a configured profile. The illumination source may then be turned “off”, as set forth in step 208. Once the illumination source is turned off, the perceived intensity of the illumination source decreases in step 210. In some embodiments, the perceived illumination intensity may be decreased based upon a configured profile. The illumination source may alternatively be turned off immediately without “ramping” in some embodiments. Alternatively, the illumination source may be controlled to gradually decrease in a manner similar to the gradual increase of step 206.

FIG. 5 shows an alternative method using an analog illumination source. The analog illumination source is provided in step 300, after which the desired rate of increase is selected in step 302. The method of FIG. 5 also allows a user to select a profile for the perceived intensity increase at step 304. The illumination source is then turned “on” in step 306. Similar to the method of FIG. 4, after turning the illumination source on, the perceived intensity of the illumination source gradually increases in step 308, after which the illumination source may be turned “off” in step 310. The perceived intensity then decreases in step 312, either immediately or gradually returning to zero, as previously mentioned.

It should be understood that the term “illumination source” is intended to encompass sources used for aiming a scanner, in addition to those used for adding ambient light and/or for improving the quality of a captured image. Illumination sources used for aiming may be referred to as aiming or pointer beams. In some embodiments, the perceived intensity of the pointer beams may be increased and/or decreased, as described above in connection with ambient illumination sources.

Those of ordinary skill in the art will also appreciate that a control for activating scanning or imaging by a user may also control the illumination source. Thus, a user may activate scanning by activating the control, which may then automatically ramp up the perceived intensity of the illumination source to a desired level. Then, following scanning, the illumination source may be ramped back to zero. In some embodiments, the decrease ramping may be triggered upon release of the scanning control, such as a trigger. Alternatively, reactivation of the control, or activation of a separate control, may be used to initiate the downward ramping.

Those of ordinary skill in the art will also appreciate that the inventive principles set forth herein are applicable to a variety of different devices. For example, some embodiments of the invention may comprise hand-held scanners/readers. Other embodiments of the invention may comprise fixed or “handable” imaging scanners, which typically sit on a retail counter. Some fixed scanners do not include a trigger or switch for activation at all. Instead, the scanner may sense when an item is brought within its range and automatically activate the illumination. Of course, some hand-held scanners may be placed in a holder or stand and thereby operate in a similar mode to the fixed scanners, whereby the illumination source is activated when an object is sensed in a field-of-view. In any of the foregoing embodiments, once a label is read, or a time period has passed, the illumination may be configured to be automatically deactivated, rather than deactivated manually, if desired.

Each of the illumination sources described herein are examples of means for illuminating an optical code on an item. Each of the imaging devices set forth herein, including optical/imaging sensors and sensor arrays, are examples of means for reading the optical code. Examples of means for activating an illumination source or a means for illuminating include buttons, switches, triggers, dials, and the like. Examples of means for ramping the intensity of an illumination source or a means for illuminating perceptible to a user include circuitry for modifying an illumination-driving waveform, such as by gradually increasing the duty cycle of the waveform.

The terms and descriptions used herein are set forth by way of illustration only and are not meant as limitations. Those skilled in the art will recognize that numerous variations and modifications can be made to the details of the above-described embodiments without departing from the underlying principles of the invention. The scope of the invention should therefore be determined only by the claims, and their equivalents.

1. A data reader, comprising:
an illumination source for illuminating an optical code on an item;
a sensor for reading the optical code; and
a control for activating the illumination source according to an illumination sequence whereby an intensity of the illumination sequence perceptible to a user is gradually increased.

2. The data reader of claim 1, wherein the illumination source comprises a digital illumination source, and wherein the intensity of the illumination source perceptible to the user is gradually increased by gradually increasing a duty cycle of the illumination source.

3. The data reader of claim 1, wherein the control is configured to activate a reading process.

4. The data reader of claim 1, further comprising a second control for activating a reading process.

5. The data reader of claim 1, wherein the data reader comprises an imaging reader.

6. The data reader of claim 5, wherein the sensor is synchronized with the illumination source such that integration of an image of the optical code on the sensor takes place during a pre-selected portion of the illumination sequence.

7. The data reader of claim 1, further comprising a rate control configured to allow for user selection of a rate of increase of the intensity of the illumination source perceptible to a user.

8. The data reader of claim 1, further comprising a profile control configured to allow for user selection of one of a plurality of profiles characterizing the illumination sequence.

9. The data reader of claim 8, wherein the plurality of profiles includes at least one of a linear intensity profile, an exponential intensity profile, and a sinusoidal intensity profile.

10. The data reader of claim 1, further comprising a mode control configured to allow for user selection between a standard illumination mode in which the control activates the illumination source without gradually increasing the intensity of the illumination source perceptible to a user and a ramping illumination mode in which the control activates the illumination source by gradually increasing the intensity of the illumination source perceptible to a user.

11. The data reader of claim 1, wherein the illumination sequence gradually increases the actual intensity of the illumination source.

12. The data reader of claim 1, wherein the illumination source is further configured to gradually decrease the intensity of the illumination source perceptible to a user.

13. The data reader of claim 12, wherein the data reader is configured to gradually increase the intensity of the illumination source perceptible to a user in response to a first actuation of the control, and wherein the data reader is configured to gradually decrease the intensity of the illumination source perceptible to a user in response to a second actuation of the control.

14. The data reader of claim 13, wherein the second actuation of the control comprises releasing the control.

15. The data reader of claim 13, wherein the first actuation of the control comprises sensing an object within a field of view of the data reader.

16. The data reader of claim 13, wherein the second actuation of the control comprises sensing a predetermined time period of inactivity.

17. A data reader, comprising:
means for illuminating an optical code on an item;
means for reading the optical code;
means for activating the means for illuminating; and
means for ramping a perceived intensity of the means for illuminating.

18. The data reader of claim 17, wherein the means for activating the illumination source comprises a trigger.

19. The data reader of claim 17, wherein the means for ramping a perceived intensity of the means for illuminating comprises circuitry configured to ramp an intensity of an illumination source by gradually increasing a duty cycle of a waveform driving the illumination source.

20. A method for varying perceived illumination intensity of an illumination source on a data reader, comprising the steps of:
actuating a control on a data reader;
responsive to actuation of the control, initiating an illumination sequence associated with an illumination source on the data reader, wherein the illumination sequence comprises gradually increasing an intensity of the illumination source perceptible to a user;
reading an optical code illuminated by the illumination source; and
turning the illumination source off.

21. The method of claim 20, wherein the step of reading an optical code is also initiated responsive to the actuation of the control.

22. The method of claim 20, further comprising actuating a second control on the data reader, wherein the step of reading an optical code is initiated responsive to actuation of the second control.

23. The method of claim 20, wherein the illumination sequence comprises gradually increasing a duty cycle of the illumination source.

24. The method of claim 20, wherein the step of turning the illumination source off comprises initiating a de-illumination sequence on the data reader, and wherein the de-illumination sequence comprises gradually decreasing the intensity of the illumination source perceptible to a user.

25. The method of claim 24, wherein the de-illumination sequence is initiated in response to an actuation of the control.

26. The method of claim 25, wherein the control comprises a trigger, and wherein the de-illumination sequence is initiated in response to releasing the trigger.

27. The method of claim 25, wherein the control comprises a trigger, and wherein the de-illumination sequence is initiated in response to a double click of the trigger.

28. The method of claim 20, wherein the step of reading an optical code is synchronized with the illumination sequence such that an image of the optical code is read during a pre-selected portion of the illumination sequence.
